(19) United States
(12) Patent Application Publication
(10) Pub. No.: US 2005/0002278 A1
(43) Pub. Date: Jan. 6, 2005

(54) Radio clockwork mechanism having a detector for setting the clock hands

(76) Inventor: Andreas Dittrich, Seebach (DE)

Correspondence Address: BURNS DOANE SWECKER & MATHIS L L P, POST OFFICE BOX 1404, ALEXANDRIA, VA, 22313-1404, US

(21) Appl. No.: 10/498,875

(22) PCT Filed: Dec. 13, 2002
(86) PCT No.: PCT/EP02/14247

(30) Foreign Application Priority Data
Dec. 17, 2001 (DE) 10161854.9

(51) Int. Cl. G04B 19/04

(52) U.S. Cl. 368/80

(57) ABSTRACT

The present invention relates to a radio clockwork mechanism which includes a movable hour hand and a mechanism for determining which hour the hour hand is currently indicating. That determining mechanism comprises hour-contact arches, a scanning mechanism, and a querying mechanism. The hour-contact arches are assigned to respective hours and are spaced apart a circular path. The scanning mechanism includes an hour-scanning device which is movable synchronously with the hour hand for sequentially scanning the hour-contact arches and giving a currently scanned hour-contact arch and an electrical potential different from all other hour-contact arches. The querying mechanism queries the hour-contact arches for determining which has the different electrical potential.

### BACKGROUND

The invention relates to a radio clockwork mechanism having a detector for setting the clock hands.

A radio clockwork mechanism of this kind is known from EP 0 204 851-A2 with a four bit wide angular encoder for an indirect quasi-continual electromechanical detection of the hour-hand position. Four circles on a printed circuit board, that are concentric relative to the hand-shaft axis, are queried for this purpose by way of four bending springs, which are insulated relative to one another, as to the radially sequential existence or non-existence of ohmic contacts in the angular position just achieved and which are binary coded via the contact pattern. This process is complicated in terms of mechanics and requires much space; moreover, due to the uncertainties with regard to the ohmic contact making in relation to the current contact pattern, such a query of the hand position is quite imprecise and, at any rate, very susceptible to interferences.

This is the reason why said publication also takes into consideration the possibility of representing the movement of the hand electronically by way of counting and storing with each hand rotation—beginning respectively with an ohmic synchronization contact making—the drive impulses for the stepping motor for the purpose of moving the hand. But the current counter result reflects the current angular position of the hand only then correctly if no slippage occurs between the electrical triggering of the stepping motor and the subsequently resulting mechanical movement of the hand via the gear train, as well as it there is no excessive looseness in the gear train from the drive motor to the hour-hand wheel.

It is therefore known from DE 35 13 961-C2 to detect the reaching of several few (typically three) defined hand positions in the course of a rotation of the hour-hand in succession and indirectly, in fact, via an optronic sensing of different spoke widths in the hour wheel during the rotational movement of the wheel mechanism. But this requires a complex algorithm. Moreover, due to the fact that in order to achieve a clear detection of the spoke widths in spite of the unavoidable gear looseness several rotational steps must be implemented during which, respectively once again, the existence or the end of the spoke widths that must be clearly distinguished are queried, any miniaturization of such a spoke query faces noticeable limits.

Building smaller is the solution described in DE 35 10 861-C2 for the triggering of a synchronization signal with precise exactness when passing through a very defined, preset hand position and starting from which, once again, the trigger impulses for the stepping motor are counted. A light barrier is envisioned at that place and for this purpose which detects the hour-hand position also indirectly, in fact, once again, on the hour-hand wheel behind the clock face. Said hand wheel and the intermediate wheel, which is located ahead of the former in the gear train thus rotating faster and even in the opposite direction of rotation of the former, engage as circle aperture disks in this light barrier, resulting in the fact that also large-surface aperture orifices not requiring much adjusting on the part of the manufacturer and still allowing a broad light beam to pass for the reliable response of the receiver of the light barrier, and ensure a response that is exact to the minute, e.g. when the hour wheel is queried, due to the only very brief aperture overlap. However, since only the reaching of a single, firmly preset hand position in the hand rotation is queried and since a customarily used clock stepping motor does not allow for a reversal of the direction of rotation, based on a coincidental starting position, comparatively quite a long time span may pass even with drive in accelerated mode, in particular at the beginning of start-up, until the constructively preset hand position (such as the 12 o'clock position from a current 02:00 o'clock position) is reached in order to swing the clock hands from this synchronized position into the desired position of the current point in time and to continue with the regular operation of the radio clockwork with its time-keeping hand-time display.

U.S. Pat. No. 4,148,181 describes a striking train control in which the full hour is detected with a contact arm.

DE 19 05 950 A1 describes a device with clockwork for giving light and sound signals that can be programmed for noting scheduled appointments. In that case, a contact is closed by way of placing a concentrically arranged contact arch on another potential than the others. When the hour hand with its fin conducts, during its rotation, the power from the contact sector to the ring, this ring allows the function to be carried out, noticeable by way of its connection to the light or the horn, and which function provides that the contact arches are queried in succession in order to determine as to which one of them has the other potential that is then being displayed.

In the radio clockwork mechanism of specification DE 198 24 840 A1, which the invention uses as a basis, the individual hour-contact arches are connected to one another via a resistance matrix. In particular, two adjacent contact arches are connected to each other by way of an electrical resistor resulting in a serial connection of electrical resistors. A sliding contact that is connected to an hour wheel scans the hour-contact arches. An evaluation device determines the electrical resistance value between a reference-contact arch and the currently scanned contact arch. The determined resistance represents an order or magnitude that can be assigned to a certain angle position of the hour wheel.

Recognizing these circumstances, the object of the invention consists in providing an analog radio clockwork mechanism of the said class with—for fast finding of the exact current hour-hand position even right after the start-up of operation and from a coincidental hand position—virtually continual monitoring of the actual movement of the hour-hand but with less inherent complexity in terms of apparatus and switching than the class-defining, complete multi-bit angular encoding.

### SUMMARY OF INVENTION

The present invention relates to a radio clockwork mechanism which comprises a movable hour hand and a mechanism for determining which hour the hour hand is currently indicating. That determining mechanism comprises hour-contact arches, a scanning mechanism, and a querying mechanism. The hour-contact arches are assigned to respective hours and are spaced apart a circular path. The scanning mechanism includes an hour-scanning device which is movable synchronously with the hour hand for sequentially scanning the hour-contact arches and giving a currently scanned hour-contact arch and an electrical potential different from all other hour-contact arches. The querying mechanism queries the hour-contact arches for determining which has the different electrical potential.

Correspondingly, a contact sequence is arranged principally along a circle and which is assigned to the division by hours of the minute distribution ring on the face of the clock, meaning that with the usual twelve-hour clock face, it is comprised of twelve contacts that are arranged in the shape of an arch adjacent to each other and at a distance from each other. Assigned to each of these hour-contact arches is on another circle, that is arranged concentrically relative to the former circle and preferably located inside the former circle, a half-hour-contact arch extending, for example, over the second half hour of an hour respectively. The contact arches are scanned by the sliding contact springs rotating synchronously with the hour hand of the clock, the hour and half-hour contact fingers. Preferably, these contact fingers are both lying on the ground potential therefore placing in the angular position, which has just been achieved, on the one of the two circular paths an hour-contact arch and in the second half hour of the hour-contact arch the half-hour-contact arch on the ground potential. A decoder logic continually queries which of the hour-contact arches is currently on the ground potential thereby detecting virtually without gaps the currently indicated hour.

If in this embodiment the angularly assigned half-hour-contact arch is not yet on ground potential, the time indicator of the hand of the clock is in the first half hour of the current hour, otherwise in the second half hour. This way, the current position of the hour hand is virtually always clearly represented by means of an hour contact and within the context of the length of the arch of the hour contact by means of the associated half-hour contact; thus the hand position on the clock face that is divided into twelve hours is always determined with an accuracy of half an hour. Therefore, at the start-up of operation the clockwork must only rotate until the change to the next half hour that follows in sequence, thereby quickly indicating the exact current hand position based upon which it is possible to effect the defined swinging of the hands to the current, actual given point in time.

But the response to the half-hour change is plagued with insecurities if only because of the unavoidable gear looseness, and even more so when dealing with the ohmic contact making of the contact finger gliding onto a contact arch. Therefore, for an exact determination of time by the half-hour, the contact query occurs only at a defined point in time; for the half-hour division of hours this is preferably exactly at the beginning of the first and of the thirtieth minute of each hour. Reliance is placed upon the light barrier detection device in accordance with DE 35 10 861-C2 for this purpose. To provide for the possibility of the half-hour, exact-to-the-second position detection by way of the referred to light barrier, in order to ensure the passage of the light the hour wheel is configured preferably with a total of 24 diametrically distributed holes or, for reasons of mechanical stability, completely made of an optically permeable material without holes. Moreover, in order for the light barrier to respond precisely, exact-to-the minute only at the beginning of the given half hour, respectively, the intermediate wheel located in the gear train before the minute wheel, therefore rotating faster and in the opposite direction, also engages in the aperture of the light barrier. A further engagement of a second-hand wheel in the light barrier as well as of the intermediate wheel, which is located before the former wheel in the gear train and rotates in the opposite direction of the second-hand wheel, as aperture disks makes it possible to detect the half-hour position with a preciseness that is exact to the second.

For the special case of a clock face with a 24-hour division per hour-hand rotation, which is encountered sometimes, the described contact grouping of 12/24 contact arches on two radii would clearly produce a determination of the current hand position that is precise to the hour and that would be detected at the time of the full hour with a precision that is exact to the second by means of the above light barrier function.

The contacts for the quasi-continuous rough but frequent, in fact every half-hour, detection of the hand position can be configured or mounted on the same side of a printed circuit board that is penetrated by the hour-hand shaft and lined with conductor paths; and on this surface said printed circuit board also carries the detection-evaluation circuit and the radio clockwork circuit, which is in this case, in particular, an autonomous time-keeping circuit and receiver, decoder, comparer and motor control the function of which is in part combined with a processor. The detection of the sequential contact arches dependent on hand position occurs in the described embodiment of an ohmic query by means of brush springs, most suitably in such a way that the decoding and evaluation circuit determines if in the context of the current angular position of the hour hand one or two contacts are now placed on the ground potential. Because this way it is not necessary to move any brush springs, insulated relative to each other and rigidly in relation to each other, and to connect them via their own commutators to the evaluation circuit; in that case, it is sufficient to bend all of the brush springs as contact fingers from a single disk made of spring-elastic, electrically conducting material that is rigidly caught by the hour-hand shaft and to continually place this contact disk on ground potential by means of another finger over a contact ring. The continual joint ground potential creates moreover the advantage of a contact query that is electrically quite interference-proof, because it is shielded in terms of the potential. In fact, within the radius of the contacts, that are extending in the shape of an arch, this creates a space that is electrically quite nicely shielded between the contact disk that is on the ground potential and the circuit board in which is most suitably arranged the optical receiver of an optoelectronic detector, designed e.g. as a bifurcated light barrier, for the light barrier in the gear train of the hand mechanism for the periodic release of the contact query, whereby the work mode of said receiver enjoys excellent protection against environmental influences.

It is additionally possible that another contact finger accesses the printed circuit board, in fact in this instance a continuous contact ring, from the central contact disk that is rotating with the hour hand, which is, in that case, the triggering of an alarm signal. This contact finger as a whole is most suitably held electrically insulated by a spacer ring relative to the alarm contact ring. But for a certain angular position of the hand (which means a certain time on the clock face) the spacer ring has an interruption through which it is possible for the contact finger to drop down on the alarm signal trigger making contact when the hand is in a corresponding position, and without the need of having to axially displace yet another wheel of the clockwork for this alarm signal trigger. The spacer ring can be rotated around the axis of the hand shaft which makes it possible to adjust the click interruption manually to a certain time at which the spacer ring remains frictively secured relative to the rotational movement, when the alarm contact finger has lifted off once again from the alarm contact ring via an ascending ramp at the click opening in order to continue being rotated in a synchronous fashion with the hour hand on the spacer ring until the click opening is reached once again after a rotation of the hour hand.

In order to guide the contact disk with its contact fingers, which are flexibly supported against the printed circuit board (or the alarm spacer ring), without jamming during the rotational movement, it is possible to configure the described group of contact fingers for the purpose of the symmetric force distribution as offset several times relative to each other, approximately by 120° or 180°. This avoids overturning moments on the contact disk and, via the disk, on the hour shaft.

### BRIEF DESCRIPTION OF THE DRAWINGS

Further improvements and variations as well as additional characteristics and advantages of the invention are derived from the subsequent description of an embodiment of the solution according to the invention. The drawing is limited to the essential aspects and renders a sketch in the approximately appropriate dimensions, wherein.

FIG. 1 depicts a partial axial longitudinal section, the wheels of an electromechanical radio clockwork mechanism with analog display featuring an angular position query according to the invention of the hour hand and an alarm signal switch that is additionally integrated in the latter; and

FIG. 2 shows a functionally representative contact pattern for the half-hour query of the hour-hand position in accordance with FIG. 1.

### DESCRIPTION OF A PREFERRED EMBODIMENT

The sketched electromechanical radio clockwork mechanism 11 is equipped for the analog time display on the free front ends of a hollow hour-hand shaft 13, an also hollow minute-hand shaft 14, which is fastened in the former with the ability to rotate, and a central second-hand shaft 15 respectively with a hand seat 16 for clamping on the clock hands (now shown), and the hand seat is located before a housing front part 12 used as a clock face carrier. The hour-wheel and minute-wheel hollow shafts 13, 14 are, however, not centered by means of the second-hand shaft 15 but instead by means of a support tube 17 on a housing-mounted base plate 18 surrounding said shafts.

A minute wheel 19 that is rigidly connected to the minute-hand shaft 14 is supported axially relative to its hand seat 16 against the base plate 18 and carries on its part coaxially an hour wheel 20 that is rigidly connected to the hour-hand shaft 13. Both are connected to each other by way of a gearing via an intermediate wheel 21 with the intermediate wheel being driven by the pinion 22 of the minute wheel 19 and the pinion on its part driving the wheel 20 with a pinion 23 while reversing the direction of rotation and effecting gear ratio reduction. For this purpose, the intermediate wheel 21 is supported on a fulcrum pin 24 between the base plate 18 and a printed circuit board 25 arranged mounted to the housing. The electromagnetic stepping motor for driving the second wheel 26 and the further intermediate wheels (between the stepping motor and the second wheel 26 and between the motor and the minute wheel 19) as well as the complete, transversally operating light barrier 55 are not covered in the described step.

The printed circuit board 25 carries on its surface 27, which is directed away from the base plate 18 and is therefore directed towards the housing front part 12, a contact ring 28 that concentrically surrounds the hour-hand shaft 13 and that is specially mounted or realized by way of the corresponding course of a conductor path lining. The free front end of a contact finger 29, that is configured as a bending spring, is supported, spring-preloaded, against this contact ring. The contact finger 29 can be rigidly rotated with the hour-hand shaft 13 around the central axis 30 of the clockwork mechanism 11. The contact finger is bent out of a contact disk 31 that is punched out of springy metal, and said contact disk is pushed with its central opening 32 from the hand seat 16 with sliding friction onto the hour-hand shaft 13 until it is elastically supported, spring-preloaded, with its contact finger 29 against the contact ring 28 on the printed circuit board 25; this results in a slight denting of the disk 31 in the area of its central opening 32 causing a keying on the external jacket surface of the hour-hand shaft 13. A radial recess of the central opening 32 on the external jacket surface of the hour-hand shaft 13 is penetrated by an axis-parallel fin 33 as safety against displacement of the contact disk 31 relative to the hour-hand shaft 13.

Hour-contact arches 34, which are insulated relative to one another, extend along a circle that is concentric relative to the contact ring 28 on the surface 27 of the printed circuit board 25 in accordance with the hour division on the minute distribution of the clock face, which means twelve of them regularly arranged. Above them, an hour-contact-scanning finger 35 is turning synchronously with the movement of the hour hand, i.e. synchronously with the hour-hand shaft 13; the hour-contact finger is also bent out of the contact disk 31, as can be seen from the drawing. This way, it is always that hour-contact arch 34 that is short-circuited with the contact ring 28 via the two contact fingers 29-35 and their joint contact disk 31 that is currently assigned to the current rotation angle position of the hour wheel 20 and therefore to a current hour-angle position in front of the clock face. Which of the contact arches 34 is affected at a given instance is determined via an evaluation circuit 36 that is connected on the printed circuit board 25 to the contact arches 34, whereby the current hand position is detected. Suitably, the respectively contacted hour-contact arch 34 is placed on the ground potential via the contact disk 31 and the contact ring 28, in particular by way of switching the contact ring 28 to ground potential via the conductor path lining of the printed circuit board surface 27.

For a more exact detection of the current angle position of the hour hand, each of the hour-contact arches 34 has assigned an half-hour-contact arch 37 on a further circle that is concentric relative to the axis of the mechanism 30, as can be seen in the second half of each of the hour-contact arches 34. During a rotation of the hour wheel 20, the half-hour-contact arches 37 are contacted one after the other by way of a further contact scanning finger 38 protruding from the contact disk 31, and that are in the displayed embodiment also sequentially placed on ground potential via the contact disk 31 and the contact ring 28. This way, the evaluation circuit 36, which is also connected to the half-hour-contact arches 37, detects via the currently prevailing ground potential not only the hour area to which the hour hand is pointing at the current time but also whether it is the first half or—because the associated half-hour-contact arch 37 has in the meantime also been placed on the ground potential—the second half of this current hour. This way, the evaluation circuit 36 is able to detect at any time in which hour interval the hour hand is located at a given time and in what half-hour interval the minute hand, which is coupled with the former by way of gearing, is located at a given time. This means that, for example, when operation of this radio clockwork mechanism 11 is started up, the current hand position is immediately known with a precision of within half an hour and, at any rate, without any long running of the gearing. Without long extended additional hand movement, the exact position of the hands becomes known with the change to the next half-hour interval because at that time either only the next hour- or additionally the next half-hour-contact arch 34 and/or 37 as well is placed on ground potential. An electrically non-conducting gap between two sequential hour-contact arches 34-34 ensures that the two are never simultaneously on ground potential, which is why the hour encoding cannot become ambiguous because the length of the arch gap is larger than that of the contact-making surface of the hour contact finger 35.

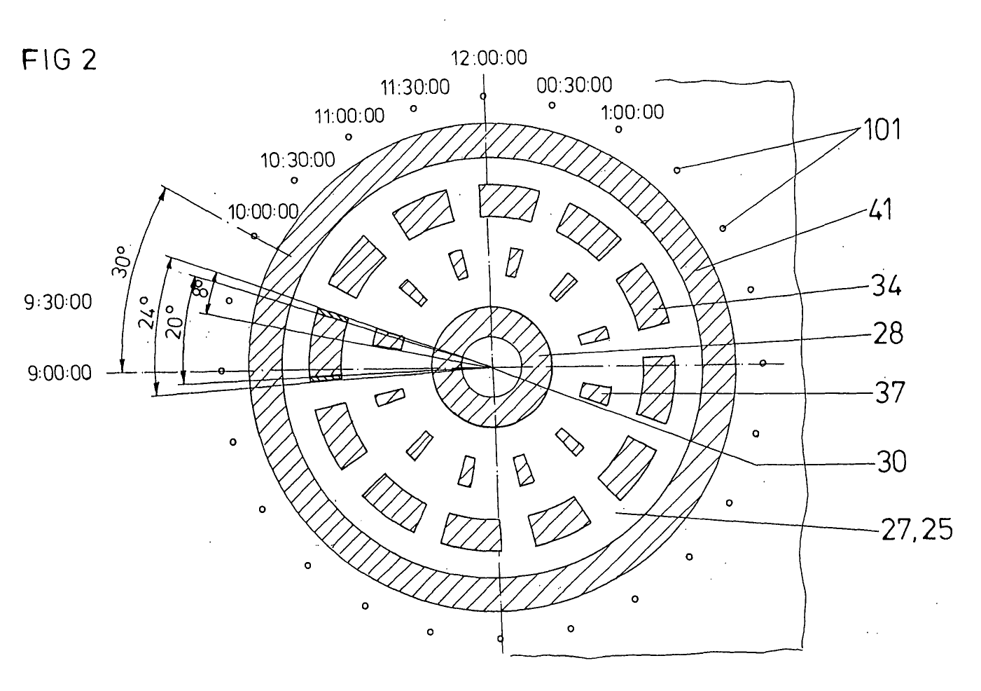

To detect the half-hour change with preciseness, even though ohmic contact insecurities and play in the gearing lead principally to a non-reproducible exactness of the responsiveness when lowering the contact potential to ground, the decoding query occurs always exactly at the time when the movement of the hand releases the path of the light of the light barrier 55 upon entering a new half-hour interval. In FIG. 2, this is symbolized with a small circle 101 in the respective angular position of the hour hand. But in order for there not to be any influences due to the previously mentioned switching insecurities at that time—because of the play of the gearing and subsequent to e.g. contact bouncing phenomena when approaching the edge of the contact arches 34 and/or 37—but to ensure that quasi-stationary potential conditions exist, the respective contact arches 34 and 37 become active even before the half-hour change on the clock face, as is indicated in the drawing with extension of the contact arches 34, 37 against the movement direction of the hand of the clock. The lowering of potential to ground potential has therefore occurred reliably and in a stationary manner, when the evaluation circuit 36 queries the contact arches in question regarding the logical half-hour decoding.

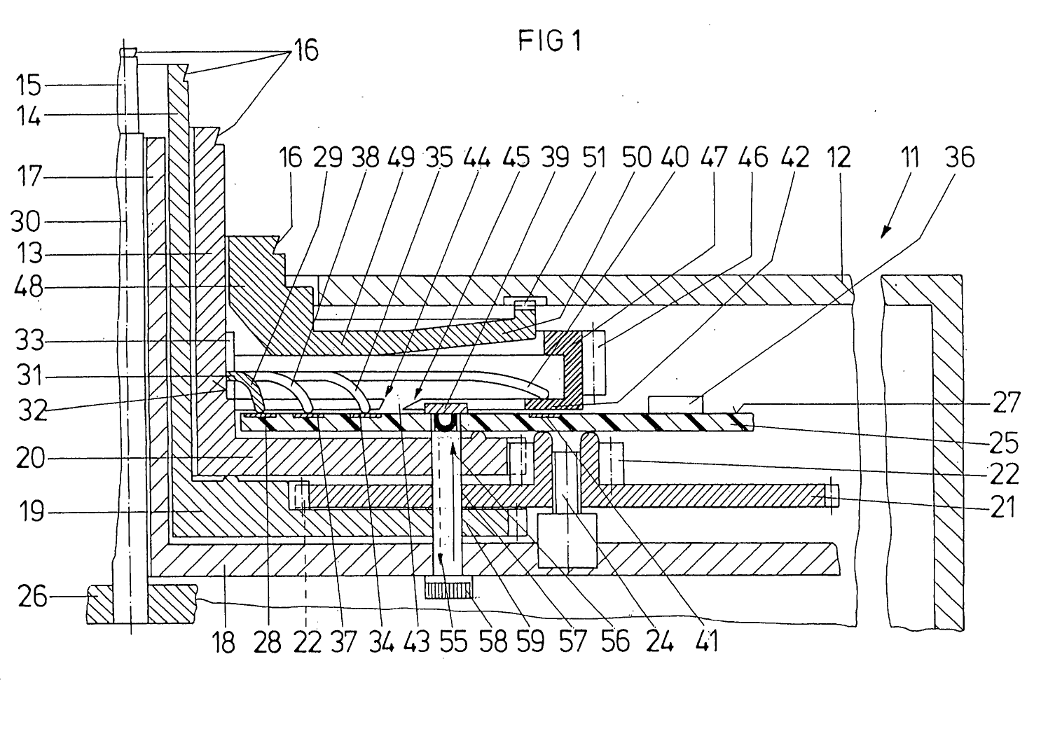

Therefore, in order to detect this half-hour change independently of the response precision of the contact finger 38 and/or 29 during the contact change, a bifurcated or, as shown in FIG. 1, reflective light barrier 55 is envisioned. The symbolically demonstrated positioning of at least its receiver 39 on the printed circuit board 25 axially below the contact disk 31, that is constantly at ground potential, has the advantage that it is electrically well shielded. Used to effect the response of the light barrier receiver 39 exactly at the half-hour change is—as described in further detail in DE 35 10 861 C2 that was referred to earlier—the course of the light barrier through a hole 57 in the intermediate wheel 21 and through the hour wheel 20, optically transparent or equipped with 24 holes 56, that is driven by pinion 22 of the intermediate wheel.

In fact, the contact fingers 29, 35, 38 are not, as seen in the simplified drawing, all arranged along the same radius of the contact disk 31, but they are offset relative to each other at an angle in order for the contact disk 31 to be able to press against the printed circuit board 25 without keying.

Since the contact disk 31 turns synchronously with the hour wheel 20, which means it turns with the hour hand before the clock face, it is useful to realize a further contact finger 40 on the contact disk that serves to trigger an alarm. But to ensure that during its time-keeping rotation said trigger is not continually supported, while making contact, on an alarm contact ring 41 on the printed circuit board surface 27, an electrically insulating spacer ring 42 is arranged between the two, which can also be electrically conducting if it is insulated relative to the alarm contact ring 41 by way of a coating or by way of a distance. The distance ring 42 has only at one location of its circumference axially above the alarm contact ring 41 a radial click opening 43 for the passage of the alarm contact finger 40. Therefore, when said alarm contact finger reaches this angular position in the course of its time-keeping movement with the hour wheel 20, it snaps through click opening 43 along a steep click edge 44 until the axis-parallel contact against the alarm contact ring 41 is achieved. This way, it is placed on ground potential via the contact disk 31 and the contact ring 28 and which is why an alarm signal is released via the evaluation circuit 36 for broadcast. Employing a lifting ramp 45 with only a flat incline in comparison to the click edge 44, the alarm contact finger 40 is lifted up onto the distance ring 42 again, while the hour wheel 20 continues to turn, which means the alarm contact finger is lifted away from the alarm contact ring 41 until the click occurs once again after the hour hand completes a rotation.

The distance ring 42 with its click opening 43 is thus, on the whole, mounted to the housing, and thus rigidly attached to its alarm contact finger 40 relative to the rotation movement of the hour wheel 20. The angle position of the distance ring 42 with its click opening 43, however, is manually adjustable by its gearing via a front gearing 46, and by way of which the trigger time for the alarm signal can be variably preset. For this purpose, the distance ring 42 is configured as a radially protruding circling flange on the internal jacket surface of a internal gear wheel 47 as can be seen in the cross-sectional representation in the drawing. The internal gear wheel 47 is arranged radially, with a hollow fulcrum pin 48 projecting from its wheel disk 49 at the free front end of which a hand seat 16 is realized for the alarm hand, on the hour-hand shaft 13 in the housing front part 12 and arranged axially between the housing front part 12 and the printed circuit board 25. For the purpose of arresting the angle position of the click opening 43 in the distance ring 42 that is preset via the front gearing 46—against the rotation of the alarm contact finger 40 supported thereon—a spring arm 50 extends off the wheel disk 49 which is oriented in a parallel direction relative to the housing front part 12 and which elastically supports itself with its free front end against the internal wall of the housing front part 12 and uses the latter as friction. As shown in the drawing, it is possible to envision at this location even a latch click that acts as back-stopping device 51 in order to prevent that the click opening 43 is being turned relative to the alarm contact finger 40 vis-à-vis the steep click edge 44, and that instead it can only be turned by way of the lifting ramp 45. This ensures simultaneously that any turning of the distance ring 42 does not result via the alarm contact finger 40 in the concomitant rotation of the hour wheel 20, indicating an erroneous display of the hour hand before the clock face.

At any rate, the solution according to the invention provides for an electromechanical radio clockwork mechanism 11 with analog display for achieving one of many hand-reference positions quickly and automatically, in particular without the need for a long running of the gearing for moving the clock hands into one of only a few or even into a single reference position. The detection of attaining the reference position, on the other hand, does not require the complexity of the instrumentation for a multiple digit, binary coded angle sensor with its susceptibility to multiple contact making, as well as there is no need for the query of varying spoke widths in the hour wheel representing poor suitability for miniaturization. Instead, twelve contact arches 34 that are assigned to the division of hours on the clock face are scanned at a given time in succession with the rotation movement of the hour wheel 20 thereby providing rough information regarding the current hour orientation of the hour hand in the context of which the current half hour is queried via another contact arch 37. The moment the query takes place at the beginning of each half hour is very exactly preset by way of a sensor in the hand-clockwork gearing, in particular a light barrier. For the successive query of the contact arches 34 and 37, the contact arches 34 and 37 are suitably, via contact fingers 35 and/or 38, placed on ground potential, one after the other, on a joint contact disk 31 that rotates with the hour wheel 20 and via a contact ring 28. The contact disk 31 can additionally be equipped with an alarm contact finger 40 that rotates on a spacer ring 42 above an alarm contact ring 41 but that contacts at an angular position, which can be preset via a radially oriented, slot-shaped click opening 43 in the spacer ring 42, the alarm contact ring 41 in order to trigger an alarm signal ring 42 without the need of having to axially displace any of the wheels that carry the hands from the hand clockwork mechanism.

1-13. (canceled)

14. Radio clockwork mechanism comprising a movable hour hand and a mechanism for determining which hour the hour hand is currently indicating, comprising:
hour-contact arches assigned to respective hours and spaced apart along a circular path,
a scanning mechanism including an hour-scanning device movable synchronously with the hour hand for sequentially scanning the hour-contact arches and giving a currently scanned hour-contact arch an electrical potential different from an electrical potential of all other hour-contact arches, and
a querying-mechanism for querying the hour-contact arches for determining which has the different electrical potential.

15. Radio clockwork mechanism claimed in claim 1 further including half-hour-contact arches spaced apart along a circular path concentric with, and having a different radius than, the circular path of the hour-contact arches; each half-hour-contact arch being associated with a respective hour-contact arch; the scanning mechanism including a half-hour-scanning device movable synchronously with the hour hand for sequentially scanning the half-hour contact arches and giving a currently scanned half-hour contact arch an electrical potential different from an electrical potential of all other half-hour-contact arches; the querying mechanism arranged for querying the half-hour contact arches for determining which has the different electrical potential.

16. Radio clockwork mechanism as claimed in claim 15 further including an hour wheel connected to the hour hand; the scanning mechanism further including a contact ring arranged concentrically relative to the circular path of the hour-contact arches and having a selected electrical potential; the scanning mechanism including a contact disk rigidly connected to the hour wheel; the hour-scanning device including an hour-scanning finger extending from the contact disk and arranged to make contact with the hour-contact arches, the half-hour scanning device comprising a half-hour scanning finger extending from the contact disk and arranged to make contact with the half-hour contact arches; and a contact finger extending from the contacting disk and the contact ring for connecting the hour-scanning finger and the half-hour scanning finger with the potential of the contact ring.

17. Radio clockwork mechanism as claimed in claim 16 wherein the potential of the contact ring is ground potential.

18. Radio clockwork mechanism according to claim 16, further including an hour-hand wheel connected to the hour hand, the querying mechanism including a light barrier extending across a path of travel of the hour hand wheel, wherein the querying of the hour-contact arches is initiated in response to the beginning of a half-hour-period.

19. Radio clockwork mechanism according to claim 18 wherein the light barrier is disposed below the contact disk.

20. Radio clockwork mechanism as claimed in claim 16 including an hour-hand shaft connected to the hour hand; wherein the contact disk includes a central opening and is mounted on an external surface of the hour-hand shaft for rotation therewith.

21. Radio clockwork according to claim 16 further including an alarm mechanism comprising a spacer ring rotatable relative to the hour hand shaft and including: an alarm opening, an alarm contact ring coaxial with the circular path of the hour-contact arches, and an alarm contact finger extending from the contact disk and held out of contact from the alarm contact ring by the spacer ring until reaching the alarm opening.

22. Radio clockwork mechanism according to claim 21 wherein the alarm opening includes first and second edges, one of which being less steep to raise the alarm finger out of the alarm opening during rotation of the spacer ring.

23. Radio clockwork mechanism according to claim 21 wherein the spacer ring comprises part of a gear wheel that is connectable to an alarm hand and rotatable about the hour-hand shaft.

24. Radio clockwork according to claim 23 wherein the gear wheel carries a spring arm bearing yieldably against an outer housing of the radio clockwork mechanism.

25. Radio clockwork according to alarm 24 wherein the housing carries a one-way structure engaging the spring arm for permitting rotation of the spacer ring in only one direction.

26. Radio clockwork mechanism as claimed in claim 14, further including an hour-hand wheel connected to the hour hand, the querying mechanism including a light barrier extending across a path of travel of the hour hand wheel, wherein the querying of the hour-contact arches is initiated in response to the beginning of a half-hour-period.

27. Radio clockwork mechanism according to claim 26, further including a minute hand and a minute hand wheel connected thereto, and an intermediate wheel for transmitting rotation between the minute hand wheel and the hour hand wheel; wherein the hour hand wheel, the minute hand wheel and the intermediate wheel include respective light emitting passages that are alignable to conduct the light barrier at the beginning of the half-hour.
